(19) United States
(12) Patent Application Publication
(10) Pub. No.: US 2004/0137405 A1
(43) Pub. Date: Jul. 15, 2004

(54) Method for preparing a full denture device

(76) Inventor: Cheng-Kuo Fang, Kaohsiung City (TW)

Correspondence Address: BAKER & DANIELS, 111 E. WAYNE STREET, SUITE 800, FORT WAYNE, IN, 46802

(21) Appl. No.: 10/339,039

(22) Filed: Jan. 9, 2003

(51) Int. Cl. A61C 13/00

(52) U.S. Cl. 433/167

(57) ABSTRACT

In a method for preparing a closely fittable full denture device, a molded full denture is prepared to roughly correspond to contour of a patient's hard palate and vacated gum. The molded full denture includes a palatal arch portion with an inner palatal arch wall surface which is adapted to match and confront the hard palate and which has a cavity. The inner palatal arch wall surface is then coated with a layer of curable resin paste, and is pressed against the hard palate to obtain an impression. Thereafter, the impressed resin paste layer is cured to obtain the closely fittable full denture device.

### BACKGROUND OF THE INVENTION

1. Field of the Invention

This invention relates to a method for preparing a full denture device, more particularly to a method for preparing a closely fittable full denture device.

2. Description of the Related Art

In a conventional method for preparing a full denture device, a molded full denture is first formed by having the patient bite an appropriate material to obtain an impression which corresponds to the contour of the patient's natural hard palate and vacated gum, and by arranging a plurality of artificial teeth on a denture base part of the impressed material. The molded full denture is then processed to forma full denture device. Thereafter, the full denture device is slightly adjusted and trimmed. Referring to FIG. 1, a full denture device 15 formed according to the above method includes an encasement portion 163 to be attached to the patient's vacated gum, a palatal arch portion 162 to be attached to the patient's hard palate, and artificial teeth 171. However, after the full denture device is mounted in the patient's mouth, the encasement portion 163 is liable to be undesirably dislodged from the vacated gum after a period of use. Moreover, in such a method, the adjustment and trimming of the molded full denture are complicated and time consuming.

Referring to FIG. 2, in another conventional method, magnets 21,22 are respectively mounted into an encasement portion of a full denture device 2 and the patient's vacated gum 3 for attracting each other and for enhancing the adhering strength therebetween. However, this results in increased costs and discomfort to the patient.

### SUMMARY OF THE INVENTION

The object of the present invention is to provide a method for preparing a closely fittable full denture device which can be retained firmly in a patient's mouth, and which can be prepared within a relatively short time.

According to this invention, the method for preparing a closely fittable full denture device, comprising the steps of

(a) preparing a molded full denture which roughly corresponds to contour of a hard palate and a vacated gum of a patient, the vacated gum including front and rear gum arch surfaces opposite to each other in radial directions, and an alveolar arch surface interposed between and transverse to the front and rear gum arch surfaces;

(b) coating an inner palatal arch wall surface of a palatal arch portion of the molded full denture with a layer of curable resin paste;

(c) obtaining an impression in the resin paste layer which corresponds to the contour of the patient's hard palate by pressing the coated inner palatal arch wall surface against the hard palate of the patient; and

(d) curing the impressed resin paste layer to obtain the closely fittable full denture device.

In step (a) , the molded full denture includes an all-gum cap-cup encasement portion, the palatal arch portion, and a set of artificial teeth.

The encasement portion includes a front encasement part, a rear encasement part and a denture base part. The front encasement part has an outer front arch wall surface and an inner front arch wall surface which is opposite to the outer front arch wall surface in the radial directions and which is adapted to be disposed forwardly of the front gum arch surface. The rear encasement part has an outer rear arch wall surface and an inner rear arch wall surface which is opposite to the outer rear arch wall surface in the radial directions and which is adapted to be disposed rearwardly of the rear gum arch surface. The denture base part extends in a transverse direction relative to and is interposed between the front and rear encasement parts. The denture base part has an upper arch wall surface which is adapted to confront the alveolar arch surface, and a lower arch wall surface opposite to the upper arch wall surface in an axial direction which is transverse to the transverse direction.

The palatal arch portion is integrally formed with, and extends from the rear encasement part rearwardly and in the radial directions, and has the inner palatal arch wall surface which is adapted to match and to confront the hard palate, and an outer palatal arch wall surface opposite to the inner palatal arch wall surface in the axial direction. The inner palatal arch wall surface has an inner peripheral region which defines a cavity that extends inwardly from the inner peripheral region towards the outer palatal arch wall surface so as to form a pouch with the hard palate when the inner peripheral region is brought to abut against the hard palate.

The artificial teeth are disposed in the lower arch wall surface of the denture base part.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional full denture device;

FIG. 2 is a schematic view of another conventional full denture device;

FIG. 3 is a perspective view illustrating a molded full denture formed by a method according to a preferred embodiment of this invention;

FIG. 4 is a sectional schematic view illustrating that the molded full denture is fitted in a patient's mouth after a layer of curable resin paste is applied to an encasement portion and a palatal arch portion;

FIG. 5 is a sectional schematic view illustrating the full denture device in a state of use;

FIG. 6 is an exploded perspective view illustrating a full denture device formed by a method according to another preferred embodiment of this invention;

FIG. 7 is a sectional schematic view illustrating the full denture device in a state of use; and

FIG. 8 is a bottom view of the full denture device.

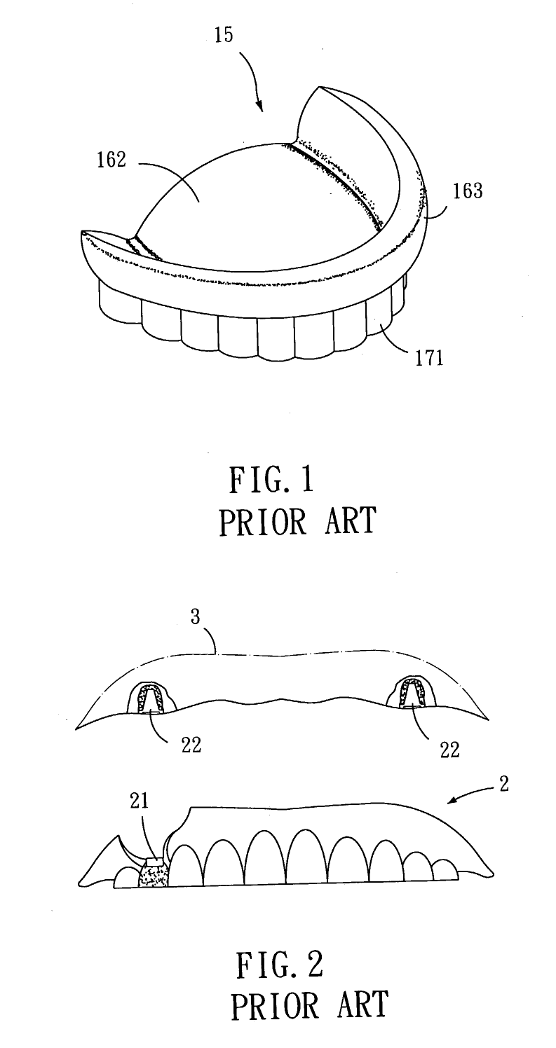

### DETAILED DESCRIPTION OF THE PREFERRED EMBODIMENTS

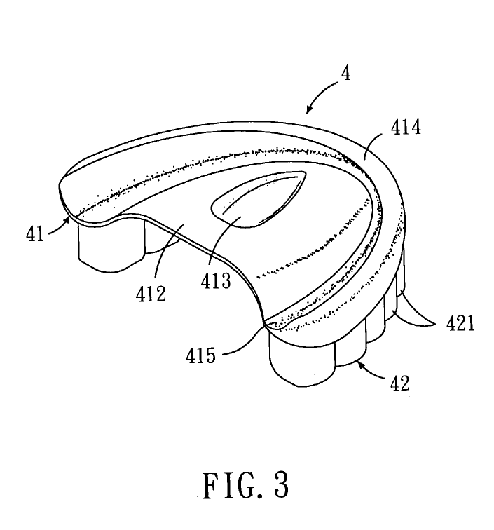

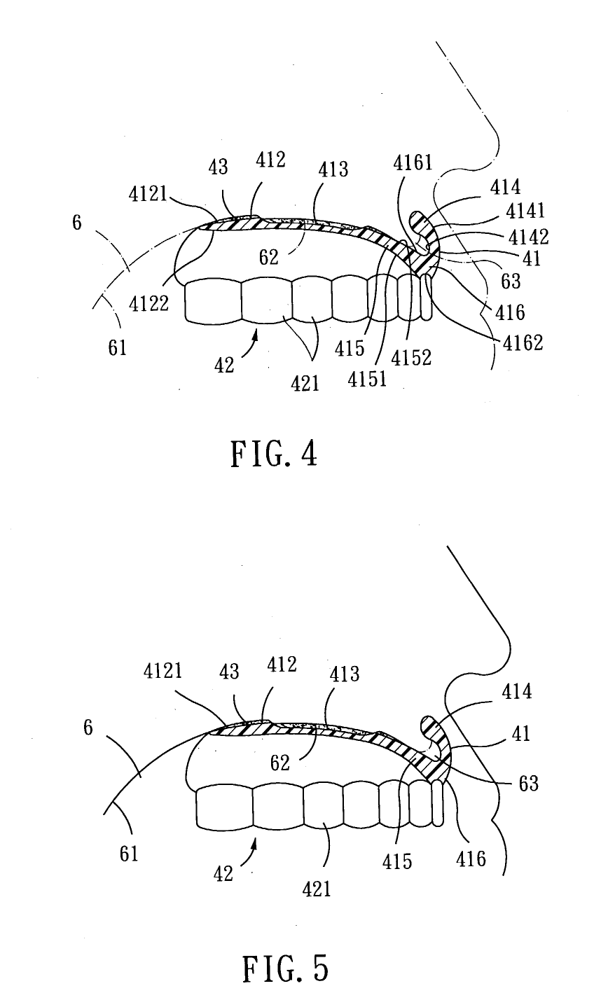

Referring to FIGS. 3 to 5, the preferred embodiment of a method for preparing a full denture device according to the present invention is shown to include the step of preparing a molded full denture 4 that roughly corresponds to the contour of a person's natural hard palate 61 and vacated gum 63. The vacated gum 63 includes front and rear gum arch surfaces opposite to each other in radial directions, and an alveolar arch surf ace interposed between and transverse to the front and rear gum arch surfaces.

The molded full denture 4 includes an all-gum cap-cup encasement portion 41, a palatal arch portion 412, and a full set of artificial teeth 421.

The all-gum cap-cup encasement portion 41 includes a front encasement part 414 , a rear encasement part 415 , and a denture base part 416. The front encasement part 414 has an outer front arch wall surface 4141, and an inner front arch wall surface 4142 which is opposite to the outer front arch wall surface 4141 in the radial directions, and which is adapted to be disposed forwardly of the front gum arch surface. The rear encasement part 415 has an outer rear arch wall surface 4151, and an inner rear arch wall surface 4152 which is opposite to the outer rear arch wall surface 4151 in the radial directions, and which is adapted to be disposed rearwardly of the rear gum arch surface. The denture base part 416 extends in a transverse direction relative to and is interposed between the front and rear encasement parts 414,415. The denture base part 416 has an upper arch wall surface 4161 adapted to confront the alveolar arch surface, and a lower arch wall surface 4162 opposite to the upper arch wall surface 4161 in an axial direction that is transverse to the transverse direction.

The palatal arch portion 412 is integrally formed with and extends from the rear encasement part 415 rearwardly and in the radial directions, and has an inner palatal arch wall surface 4121 which is adapted to match and to confront the hard palate, and an outer palatal arch wall surface 4122 opposite to the inner palatal arch wall surface 4121 in the axial direction. The inner palatal arch wall surface 4121 has an inner peripheral region which defines a cavity 413 that extends inwardly from the inner peripheral region towards the outer palatal arch wall surface 4122 so as to form a pouch with the hard palate 61 when the inner peripheral region is brought to abut against the hard palate 61.

The artificial teeth 421 are disposed in the lower arch wall surface 4162 of the denture base part 416. The artificial teeth 421 maybe formed from a block of denture teeth 42 which is processed to resemble natural teeth.

A number of the molded full dentures 4, which are formed to substantially correspond to different inner mouth contours, can thus be prepared in advance.

This invention further includes the step of coating the inner palatal arch wall surface 4121 of the palatal arch portion 412 , the inner front arch wall surface 4142 of the front encasement part 414, the inner rear arch wall surface 4152 of the rear encasement part 415, and the upper arch wall surface 4161 of the denture base part 416 of a selected one of the molded full dentures 4 which matches a patient's mouth contour with a layer of curable resin paste 43.

Subsequently, the selected molded full denture 4 is then fitted in the patient's mouth, and the inner palatal arch wall surface 4121, the inner front and rear arch wall surface 4142, 4152 and the upper arch wall surface 4161 are pressed against the hard palate 61, the front and rear gum arch surfaces, and the alveolar arch surface of the patient, respectively, to obtain an impression in the resin paste layer 43 which corresponds to the contour of the patient's hard palate 61 and vacated gum. It is noted that the cavity 413 is pressed to confront a portion of palatine processes 62 of the hard palate 61.

Thereafter, the molded full denture 4 is removed from the patient's mouth, and the resin paste layer 43 with the impression is cured.

After the resin paste layer 43 with the impression is cured, excess resin material that is formed beyond the contour of the full denture device as a result of squeezing of the resin paste layer 43 during the pressing step is trimmed, thereby obtaining a closely fittable full denture device of the present invention.

Referring to FIG. 5, in use, when air trapped in the pouch is squeezed out of the inner peripheral region of the inner palatal arch wall surface 4121, the reduced pressure in the pouch will strengthen the adhering between the inner palatal arch wall surface 4121 and the hard palate 61, thereby preventing the full denture device from being undesirably dislodged from the patient's hard palate 61.

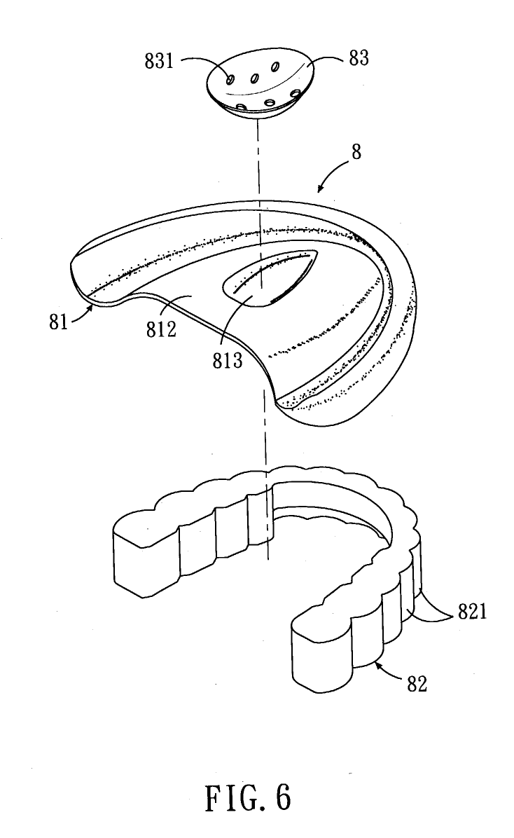

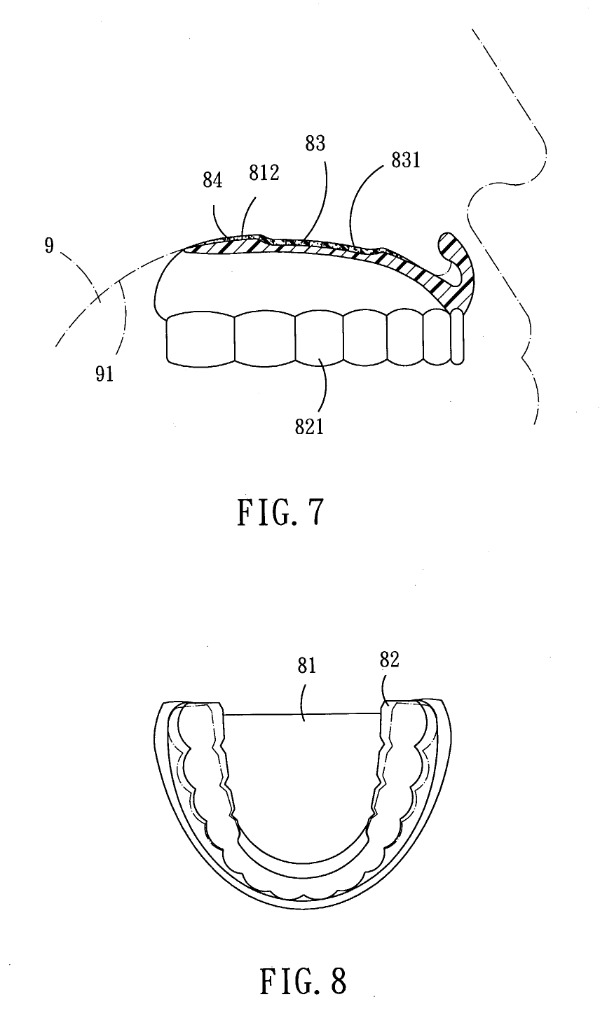

Referring to FIGS. 6 to 8, another preferred embodiment of the method for preparing a full denture device according to the present invention is shown to be similar to the previous embodiment. This embodiment further includes the step of preparing a sucker member 83. The sucker member 83 is preferably formed from an elastomeric material, such as rubber, that is more flexible than the material of the palatal arch portion 812, and is configured to have a plurality of holes 831 and to conform to the contour of the cavity 813 in the inner palatal arch wall surface of the palatal arch portion 812. As shown in FIG. 7, the sucker member 83 is disposed in the cavity 813 to form a pouch with the patient's hard palate 91. In addition, the curable resin paste 84 which is applied to the inner palatal arch wall surface of the palatal arch portion 812 is squeezed into the cavity 813 during pressing of the coated inner palatal arch wall surface against the hard palate 91 so as to fill the holes 831 in the sucker member 83, thereby providing the sucker member 83 with enhanced adhering strength. As such, the sucker member 83 is retained in the cavity 813 after the resin paste 84 is cured.

Moreover, in the step of preparing a molded full denture 8, artificial teeth 821 which are formed from a block of denture teeth 82 can be formed separately of the encasement portion 81 of the molded full denture 8. Thus, the encasement portion 81 may cooperate with a variety of blocks of denture teeth 82 to form different forms of artificial teeth 821 so as to meet the patient's demand, as shown in FIG. 8.

Due to the provision of the sucker member 83, the full denture device can be retained more firmly in the patient's mouth 9.

As illustrated, in the method according to the present invention, a number of molded full dentures 4,8 can be prepared in advance to meet patients' demand. Besides, any clearance between the molded full denture 4, 8 and the hard palate 61, 91 can be filled by the curable resin paste 43, 84 when the coated palatal arch portion 412,812 is pressed against the hard palate 61, 91—to obtain an impression. As such, a closely fittable full denture device can be formed using this method in a short time.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A method for preparing a closely fittable full denture device, comprising the steps of:
(a) preparing a molded full denture which roughly corresponds to contour of a hard palate and a vacated gum of a patient, the vacated gum including front and rear gum arch surfaces opposite to each other in radial directions, and an alveolar arch surface interposed between and transverse to the front and rear gum arch surfaces, the molded full denture comprising
an all-gum cap-cup encasement portion that includes
a front encasement part having an outer front arch wall surface and an inner front arch wall surface which is opposite to the outer front arch wall surface in the radial directions, and which is adapted to be disposed forwardly of the front gum arch surface,
a rear encasement part having an outer rear arch wall surface and an inner rear arch wall surface which is opposite to the outer rear arch wall surface in the radial directions, and which is adapted to be disposed rearwardly of the rear gum arch surface, and
a denture base part extending in a transverse direction relative to and interposed between the front and rear encasement parts, the denture base part having an upper arch wall surface adapted to confront the alveolar arch surface, and a lower arch wall surface opposite to the upper arch wall surface in an axial direction which is transverse to the transverse direction;
a palatal arch portion which is integrally formed with and extending from the rear encasement part rearwardly and in the radial directions, and which has an inner palatal arch wall surface adapted to match and to confront the hard palate, and an outer palatal arch wall surface opposite to the inner palatal arch wall surface in the axial direction, the inner palatal arch wall surface which has an inner peripheral region defining a cavity that extends inwardly from the inner peripheral region towards the outer palatal arch wall surface so as to form a pouch with the hard palate when the inner peripheral region is brought to abut against the hard palate; and
a set of artificial teeth disposed in the lower arch wall surface of the denture base part;
(b) coating the inner palatal arch wall surface of the palatal arch portion with a layer of curable resin paste;
(c) obtaining an impression in the resin paste layer which corresponds to the contour of the patient's hard palate by pressing the coated inner palatal arch wall surface against the hard palate of the patient; and
(d) curing the impressed resin paste layer to obtain the closely fittable full denture device.

2. The method according to claim 1, further comprising, after step (d) , the step of trimming excess resin material which is formed beyond contour of the full denture device as a result of squeezing of the resin paste layer during the pressing of the coated inner palate arch wall surface against the hard palate of the patient in step (c).

3. The method according to claim 2, wherein in step (b), the curable resin paste is further applied onto the inner front arch wall surf ace, the inner rear arch wall surf ace, and the upper arch wall surface.

4. The method according to claim 1, wherein in step (a), a sucker member which is configured to conform to the contour of the cavity is disposed in the cavity to form the pouch, the sucker member being made from an elastomeric material which is more flexible than the material of the palatal arch portion.

5. The method according to claim 4, wherein the sucker member is configured to have a plurality of holes such that the resin paste which is squeezed into the cavity fills the holes so as to provide the sucker member with adhering strength, thereby retaining the sucker member in the cavity when the resin paste is cured.
